(19) United States
(12) Patent Application Publication
(10) Pub. No.: US 2014/0175201 A1
(43) Pub. Date: Jun. 26, 2014

(54) Material Reducing Device

(71) Applicant: ASTEC INDUSTRIES, INC., Chattanooga, TN (US)

(72) Inventors: Arnold Neil Peterson, Eugene, OR (US); Glenn Ford Bittrolf, Springfield, OR (US)

(73) Assignee: ASTEC INDUSTRIES, INC., Chattanooga, TN (US)

(21) Appl. No.: 13/724,063

(22) Filed: Dec. 21, 2012

(51) Int. Cl. B02C 19/00; B02C 23/16; B02C 23/02

(52) U.S. Cl. CPC B02C 19/0012; B02C 23/02; B02C 23/16
USPC 241/69; 241/276; 241/95

(57) ABSTRACT

A material reducing machine includes a frame and a drum rotor which is mounted for rotation with respect to the frame. The drum rotor includes a generally cylindrical peripheral wall with a tool mounted thereon. The tool has a leading edge that defines an arc as the drum rotor is rotated, which arc is spaced outwardly from the peripheral wall and is parallel thereto. The machine includes a material input device for conveying material to be reduced towards the drum rotor, and an outlet for reduced material. A breaker bar assembly is located adjacent to the drum rotor. The breaker bar assembly includes a back plate with a plurality of breaker bars mounted thereon. The breaker bar assembly is located so that material which is carried by the tool of the drum rotor is directed against the breaker bar assembly.

### CROSS-REFERENCE TO RELATED APPLICATION

This application claims the benefit of U.S. Provisional Patent Application No. 61/630,953 which was filed on Dec. 22, 2011.

### FIELD OF THE INVENTION

The present invention relates generally to machines for use in reducing various materials, especially those obtained in a structural demolition process so that such materials can be more conveniently transported from a demolition site.

### BRIEF DESCRIPTION OF THE DRAWINGS

A prior art device is illustrated in FIGS. 1-5, and the presently preferred embodiments of the invention are illustrated in FIGS. 6-9. More particularly:

FIG. 1 is a schematic illustration of a prior art device.

FIG. 2 is a schematic illustration of the device of FIG. 1, showing it in operation with the bypass arm in the closed position at a time in which an object that is incapable of reduction first encounters the anvil.

FIG. 3 is a schematic illustration of the device of FIGS. 1 and 2, showing it in operation with the bypass arm having moved to its open position to allow the object to fall out of the device.

FIG. 4 is a schematic illustration of the device of FIGS. 1-3, showing it in operation with the bypass arm having returned to its closed position.

FIG. 5 is an illustration of a portion of the prior art device shown in FIGS. 1-4.

FIG. 6 is a schematic illustration of a first embodiment of the invention.

FIG. 7 is a schematic illustration of a second embodiment of the invention.

FIG. 8 is a perspective view of the breaker bar assembly of the device of FIGS. 6 and 7.

FIG. 9 is a perspective view of an alternative to the breaker bar assembly of FIG. 8.

### BACKGROUND OF THE INVENTION

Material reducing machines are well-known for use in connection with the demolition of a house or other structure. Such machines typically include a conveyor for moving debris such as wood, siding, roofing materials and even appliances such as water heaters toward a rotating drum having tools thereon which is contained within a housing having an anvil bar located in close proximity to the free ends of the rotating drum tools. The tools of the rotating drum carry material into contact with the anvil bar where it is broken into smaller pieces. Most commonly, a plurality of screen sections are located adjacent to and downstream of the anvil bar so that further rotation of the drum causes partially reduced material to be further reduced by successive impacts of the tools of the rotating drum until it will pass through the apertures in one or another of the screens.

Known material-reducing machines may not be suitable for use in reducing all types of materials, particularly if there is the possibility that an object which cannot be reduced, such as a large dense metal component or fragment, can be introduced into the machine. Some machines include shear pins that will break when an object that cannot be reduced is introduced, thereby allowing a portion of the machine housing to pivot or otherwise move so as to enlarge the opening through which the object can pass. In machines which include a shear pin, operator intervention is required when a pin shears to get the machine back into operating order.

In addition, known material-reducing machines may not efficiently reduce fibrous materials like roofing shingles, because it may require multiple impacts of such materials against the anvil to provide acceptable reduction.

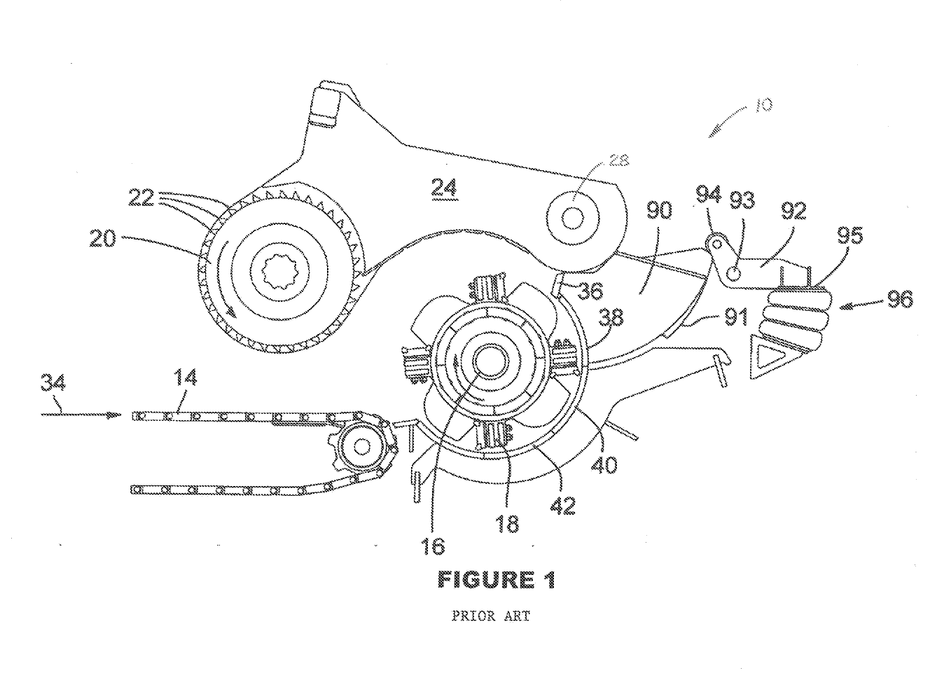

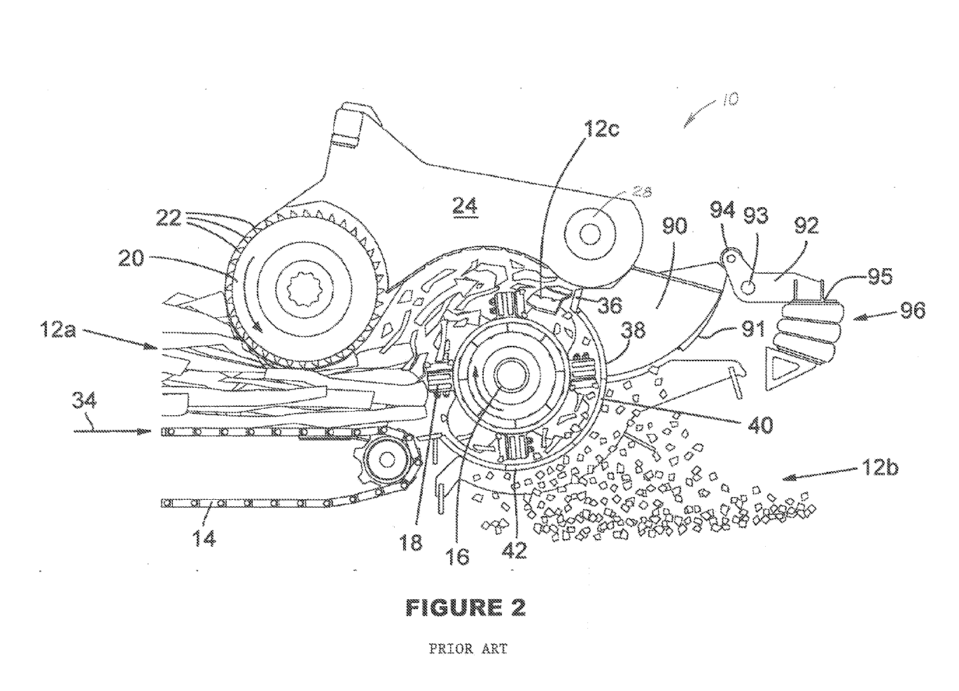

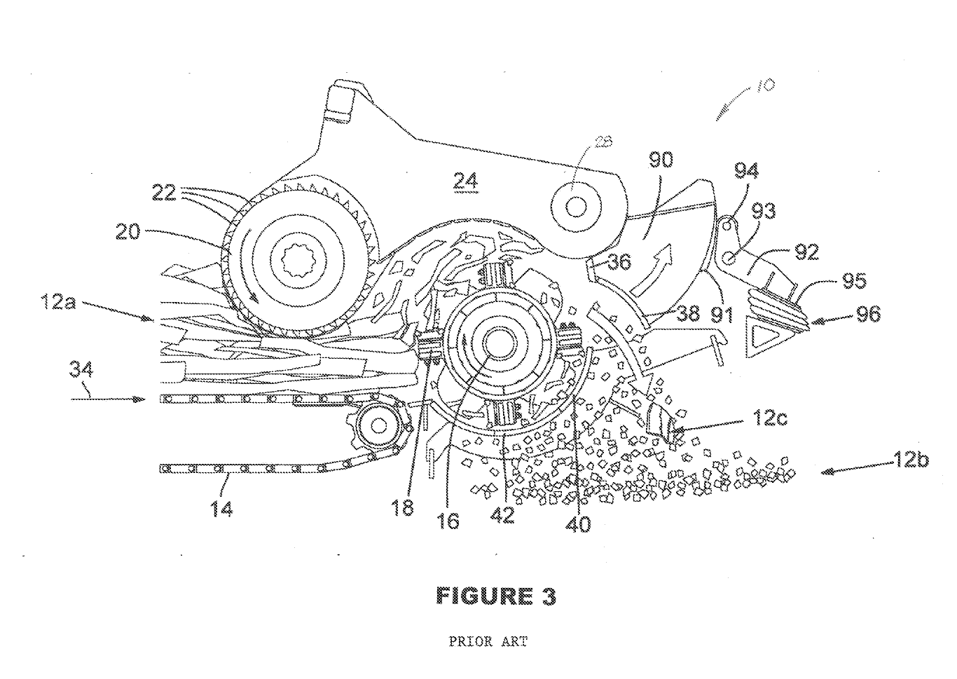

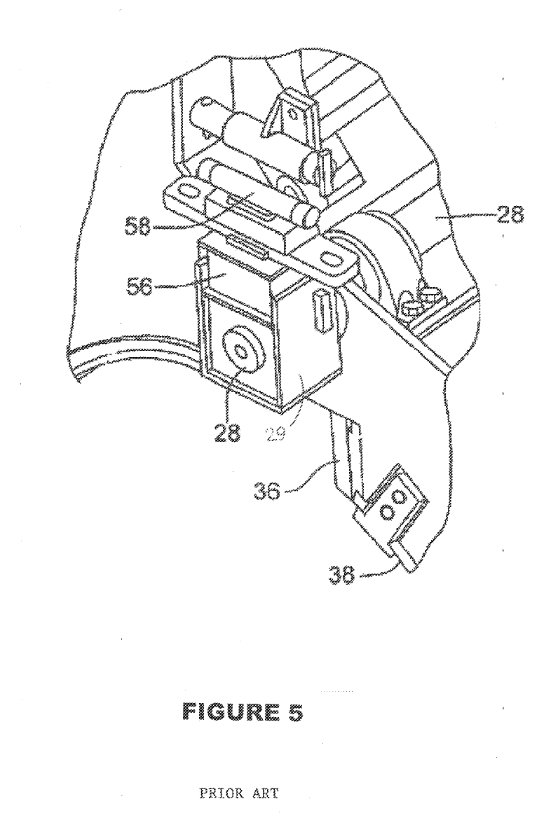

As shown in FIGS. 1-4, prior art device 10 includes conveyor 14 for moving material 12a to be reduced toward drum rotor 16 that includes radially directed tools 18 (sometimes referred to in the art as “hammers”). Compression roller 20 includes ribs 22 mounted on pivotal arm 24 so as to pivot about pivot shaft 28 (also shown in FIG. 5). Compression roller 20 cooperates with conveyor 14 to urge material 12a downward and in the direction of arrow 34 towards drum rotor 16. As shown in FIG. 2, material 12a is forced against drum rotor 16 and/or its tools 18 and is carried upwardly by tools 18 into engagement with anvil 36 that is mounted on bypass arm 90. Material 12a that is too large to pass between tools 18 and anvil 36 may be broken into smaller pieces upon impacting anvil 36. Also mounted on bypass arm 90 around the periphery of drum rotor 16 is screen section 38. Additional screen sections 40 and 42 are mounted downstream of screen section 38 around the periphery of drum rotor 16 and are fixed with respect to the frame of machine 10. Material 12a that gets past anvil 36 may be further reduced by contact with tools 18 in the space between the drum rotor and the screen sections. Reduced material 12b may then pass through one or another of the screens and onto a conveyor (not shown) for removal from the machine. Material 12a that does not pass through any of the screens on a first pass may be carried around by tools 18 one or more additional times for further contact with anvil 36 and the screen sections, until it passes through one or another of the screen sections and is carried out of the machine. When an object that cannot be reduced, such as object 12c, encounters the anvil, the force of the impact of the object on the anvil, either alone or in combination with the added impact forces imparted to the object by tools 18 of rotating drum rotor 16, will cause the bypass arm to pivot from the closed position shown in FIG. 2 to the open position shown in FIG. 3.

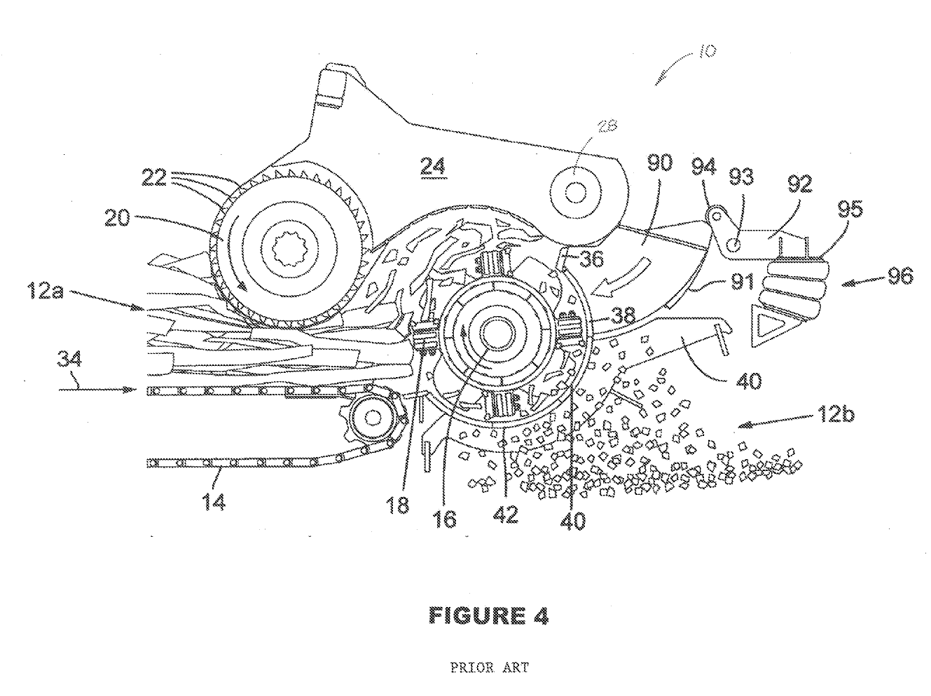

As shown in FIGS. 1-4, bypass control lever 92 is mounted so as to pivot about pivot axis 93, which is fixed with respect to the frame of the machine. Roller 94 at one end of control lever 92 is adapted to engage projection 91 of bypass arm 90. At the other end 95 of control lever 92 is mounted a resistance and biasing element such as a spring, or airbag 96, which is fixed to the frame of machine 10. As shown in FIG. 1, the contour of projection 91 is configured to provide a generally flat “home” position engageable by roller 94 and adapted to provide a predetermined force for holding control lever 92 in the position shown in FIG. 1, which in turn operates to hold bypass arm 90 in the closed position. Airbag 96 may also impose a force on end 95 of control lever 92 to assist in holding bypass arm 90 in the closed position. However, when an object such as object 12c encounters anvil 36, as shown in FIG. 2, it will apply an opening force to the anvil, and thereby to bypass arm 90, which is sufficient to overcome the predetermined force imposed by roller 94 on projection 91, and any additional force imposed by airbag 96 on end 95 of control lever 92. When this occurs, control lever 92 will pivot with respect to pivot axis 93 as shown in FIG. 3, causing roller 94 to roll down projection 91 and also causing end 95 of control lever 92 to compress airbag 96. When the bypass arm is moved to the open position, as shown in FIG. 3, and when an object such as object 12c has cleared anvil 36 and grate 38, the opening force is removed from anvil 36, and airbag 96 may apply a biasing force to pivot control lever 92, thereby causing roller 94 to roll up projection 91 to its “home” position in which bypass arm 90 has returned to the closed position, as shown in FIG. 4.

FIG. 5 illustrates in some detail the mounting of pivotal arm 24 with respect to the frame of the machine. As described above (and as shown in FIGS. 1-4), compression roller 20, which is mounted on pivotal arm 24 so as to pivot about pivot shaft 28, cooperates with conveyor 14 to urge material 12a downward and in the direction of arrow 34 towards drum rotor 16. Pivot shaft 28 is mounted for pivotal movement with respect to the frame of machine 10 in shaft support portion 29. Mounted above pivot shaft 28 and adjacent to shaft support portion 29 is compression pad 56, preferably of urethane or a similar material, which allows for limited upward movement of shaft support portion 29 and pivot shaft 28 for stress relief, i.e., such as for example, when the material reducing device is overloaded. Located above compression pad 56 is shear pin 58 which is adapted to break when upward forces greater than can be accommodated by compression pad 56 are encountered. Of course, when shear pin 58 breaks, operator intervention is required to remove the source of stress, replace the shear pin, and get machine 10 back into operating order.

Some of the prior art machines may fail to produce uniformly shaped smaller pieces. Some types of materials tend to break in elongated shapes in the prior art machines, and these elongated shapes may be difficult to handle or transport, and may therefore be generally undesirable. When these elongated shapes are able to pass through the screen sections of the prior art machines along with more uniformly sized particles, they may contaminate the resulting product with undesirable pieces.

Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

Various terms are specifically defined herein. These terms are to be given their broadest possible construction consistent with such definitions, as follows:

The term “material reducing machine” refers to a machine that is adapted to cut, chop, shred, break or otherwise reduce material into smaller pieces.

The term “aperture”, when used in connection with the back plate of the invention or with screen sections employed in connection therewith, refers to holes, slots and apertures of any convenient shape and/or size through which reduced material may pass.

The terms “upper”, “top” and similar terms, when used in reference to a relative position or direction on or with respect to a material reducing machine, or a component or portion of such a machine, refer to a relative position or direction that is farther away from the ground on which the material reducing machine is placed for operation.

The terms “lower”, “bottom” and similar terms, when used in reference to a relative position or direction on or with respect to a material reducing machine, or a component or portion of such a machine, refer to a relative position or direction that is nearer the ground on which the material reducing machine is placed for operation.

The term “front end” and similar terms refer to the end of a material reducing machine, or a component or portion of such a machine, which is nearest the point at which material to be reduced is introduced into the machine.

The terms “forward”, “in front of”, and similar terms, as used herein to describe a relative position or direction on or in connection with a material reducing machine or a component of such a machine, refer to a relative position or direction towards the front end of the machine.

The terms “back end”, “rear end” and similar terms refer to the end of a material reducing machine, or a component or portion of such a machine, which is farther from the front end of the machine, component or portion thereof.

The terms “rearward”, “behind”, and similar terms, as used herein to describe a relative position or direction on or in connection with a material reducing machine or a component of such a machine, refer to a relative position or direction towards the rear end of the machine.

The term “leading edge”, as used herein in connection with a tool that is mounted on the drum rotor of a material reducing machine, refers to the outer edge of the cutting bit of the tool which describes an arc that is parallel to the peripheral wall of the drum rotor.

The term “downstream”, as used herein to describe a relative position on or in connection with a material reducing machine, refers to a relative position in the direction of the movement of material to be reduced through the machine.

The term “upstream”, as used herein to describe a relative position on or in connection with a material reducing machine, refers to a relative position in a direction that is opposite to the direction of the movement of material to be reduced through the machine.

### SUMMARY OF THE INVENTION

The invention comprises a material reducing machine having a frame and a drum rotor which is mounted for rotation with respect to the frame. The machine also includes a breaker bar assembly that is located adjacent to the drum rotor. In one embodiment of the invention, the breaker bar assembly includes a back plate with a plurality of breaker bars mounted thereon. This breaker bar assembly is curved and mounted so as to be parallel to the peripheral wall of the drum rotor. In another embodiment of the invention, the back plate of the breaker bar assembly is mounted so that there is a generally downwardly decreasing distance between the breaker bar assembly and the arc described by the leading edge of the cutting bits of the tools on the drum rotor as the drum rotor rotates. This generally downwardly decreasing distance between the arc described by the leading edge of the cutting bits and the breaker bar assembly promotes progressive material breakage as multiple successive tools strike and break the materials against successive parts of the breaker bar assembly. In one embodiment of the invention, the back plate of the breaker bar assembly has no apertures for material to pass through, and in another embodiment, the back plate includes apertures. In one embodiment of the invention, an anvil is mounted upstream of the breaker bar assembly, and in another embodiment, there is no anvil. In a preferred embodiment of the invention, a resistance and biasing mechanism is provided between the frame and the common pivot shaft on which the pivot arm carrying the compression roller and the bypass arm carrying the breaker bar assembly are mounted. In another embodiment of the invention, a resistance and biasing mechanism is also provided between the frame and the bypass arm.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### ADVANTAGES OF THE INVENTION

Among the advantages of a preferred embodiment of the invention is that it provides a material reducing machine that breaks and reduces materials into uniformly sized pieces. Still another advantage of a preferred embodiment of the invention is that it provides such a machine which operates with greater efficiency than prior art devices. Still another advantage of a preferred embodiment of the invention is that it provides such a machine that can handle materials that are incapable of reduction without damaging the machine or stopping its operation. Other advantages and features of this invention will become apparent from an examination of the drawings and the ensuing description.

### DESCRIPTION OF THE PREFERRED EMBODIMENTS OF THE INVENTION

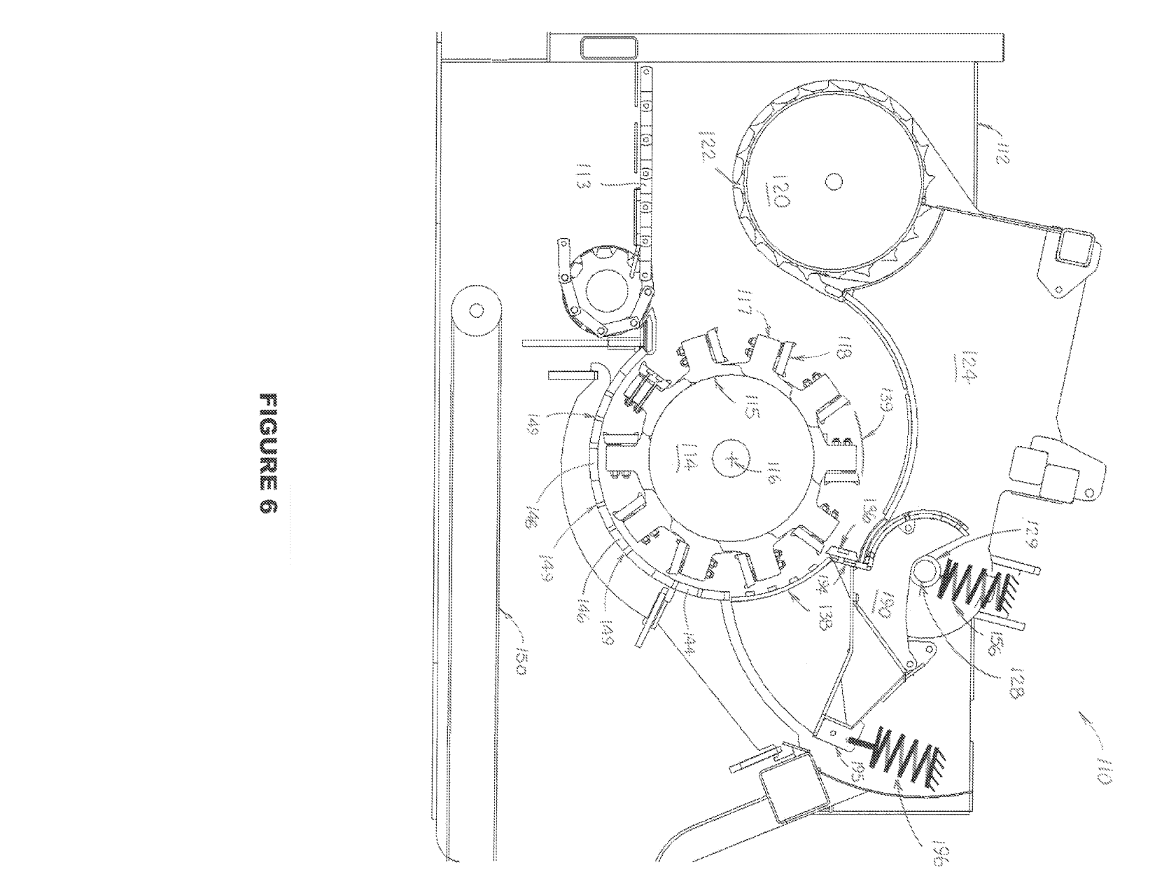

A first embodiment of the invention is illustrated in FIG. 6. As shown therein, material reducing machine 110 includes frame 112 and a material input device such as input conveyor 113. Conveyor 113 is adapted to move material to be reduced (such as material 12a shown in FIGS. 1-4) toward drum rotor 114, which has a generally cylindrical peripheral wall 115. In other embodiments of the invention (not shown in the drawings), the material input device may comprise a chute. Drum rotor 114 is adapted to rotate with respect to the frame in a clockwise direction, as shown in FIG. 6, about axis of rotation 116. Mounted on peripheral wall 115 of drum rotor 114 are a plurality of tools comprising tool holders 117 with cutting bits 118 mounted thereon. These tools are spaced around peripheral wall 115 of the drum rotor so that as the drum rotor is rotated, the tools carry material from conveyor 113 upwardly and into engagement with anvil 136 that is mounted on plate 194 of bypass arm 190. The leading edges of the cutting bits of the tools mounted on drum rotor 114 define an arc that is spaced outwardly from peripheral wall 115 and is parallel thereto. A portion 139 of this arc is shown in FIG. 6.

Compression roller 120 includes ribs 122 and is mounted on pivot arm 124. Pivot arm 124 is mounted for rotation on pivot shaft 128. Forward portion 192 of bypass arm 190 is also mounted for rotation on pivot shaft 128 (in front of pivot arm 124, as shown in FIG. 6), so that the bypass arm may pivot on pivot shaft 128 independently of pivot arm 124. Collar 129 is provided on pivot shaft 128 so that a first resistance and biasing mechanism, such as spring 156, may be mounted between frame 112 of machine 110 and collar 129 to provide for limited upward elastic movement of the pivot shaft to minimize the risk of damage or breakage of pivot shaft 128 caused by forces generated during operation of the reducing machine. The weight and placement of pivot arm 124 and compression roller 120 cause the compression roller to urge material on conveyor 113 downwardly and towards drum rotor 114. Material that is too large to pass between the leading edges of cutting bits 118 and anvil 136 may be broken into smaller pieces upon impacting anvil 136.

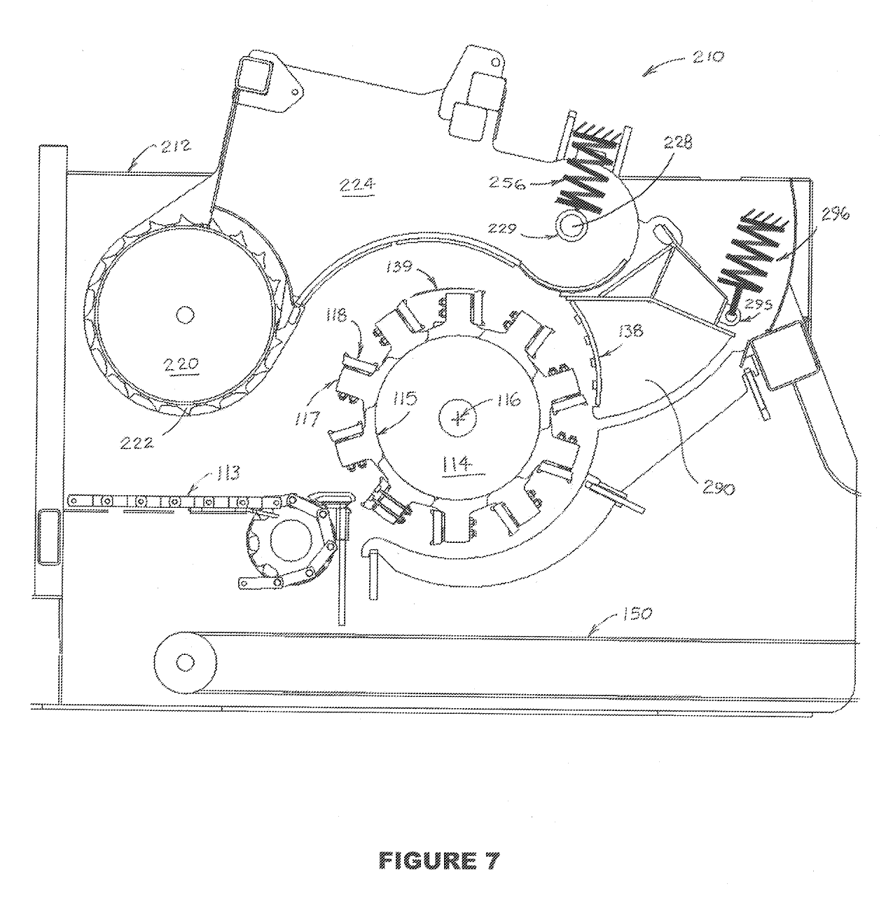

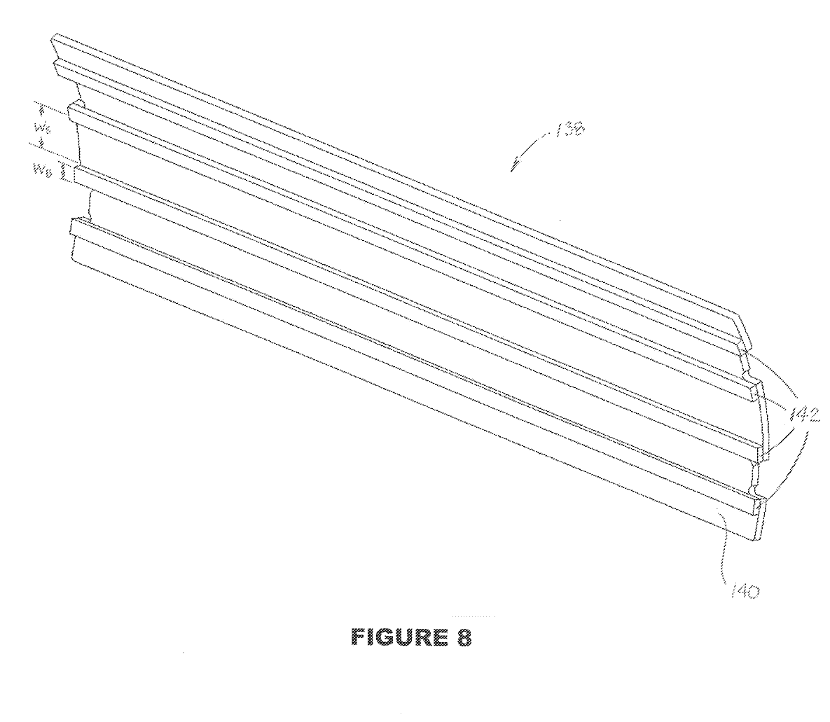

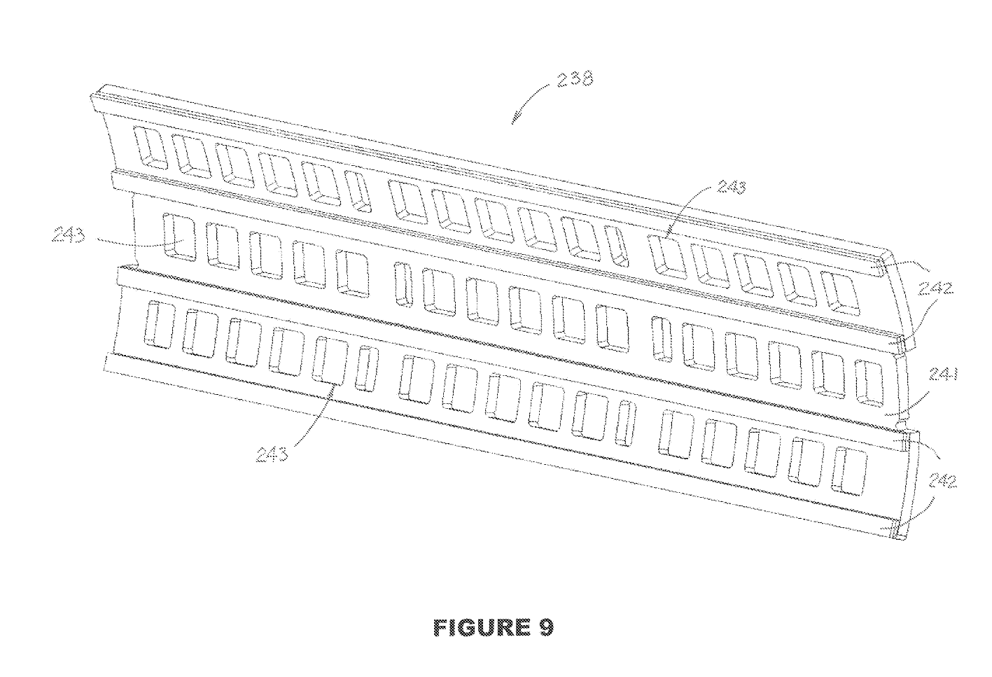

Mounted on bypass arm 190 adjacent to plate 194 is breaker bar assembly 138. As best shown in FIG. 8, breaker bar assembly 138 includes a back plate 140 and a plurality of breaker bars 142 mounted thereon. Preferably, breaker bars 142 are spaced equally across the back plate, and the width W_{B} of each breaker bar is within the range of 25-50% of the width W_{S} of the spacing between adjacent breaker bars. Most preferably, the width W_{B} of each breaker bar is about ⅜ the width W_{S} of the spacing between adjacent breaker bars. An alternative embodiment of the breaker bar assembly, assembly 238, is shown in FIG. 9. Breaker bar assembly 238, may be employed in the embodiment of the invention shown in FIG. 6 (as well as in the embodiment shown in FIG. 7 that is discussed hereinafter) instead of breaker bar assembly 138. Breaker bar assembly 238 is essentially identical to breaker bar assembly 138, except that back plate 241 includes a plurality of apertures 243 through which reduced material may pass. Thus, when breaker bar assembly 238 is used, back plate 241 will form a part of the outlet for reduced material from the machine. As shown in FIG. 9, breaker bar assembly 238 includes a plurality of breaker bars 242 mounted on back plate 241. Preferably, breaker bars 242 are spaced equally across the back plate, and the width of each breaker bar is within the range of 25-50% of the width of the spacing between adjacent breaker bars. Most preferably, the width of each breaker bar is about ⅜ the width of the spacing between adjacent breaker bars.

In the embodiment of the invention shown in FIG. 6, the back plate of the breaker bar assembly is curved and is located so as to describe an arc that is parallel to and of a slightly larger diameter than the arc that is described by the leading edges of cutting bits 118 as drum rotor 114 rotates about axis 116, a portion of which latter arc is shown as arc 139 in FIG. 6. The breaker bars of the breaker bar assembly provide additional resistance edges for cutting bits 118 to work against as the drum rotor rotates about its axis, thereby improving the efficiency of operation of material reducing machine 110. A second resistance and biasing mechanism, such as spring 196, is mounted between the frame of the machine and rear end 195 of bypass arm 190 and adapted to urge the breaker bar assembly towards the drum rotor. A plurality of screen sections 144, 146 and 148, which are preferably curved at the same diameter as the breaker bar back plate, are mounted successively downstream of breaker bar assembly 138 outside of the arc that is described by the leading edges of cutting bits 118 as drum rotor 114 rotates. These screen sections are fixed with respect to frame 112 of machine 110 and include apertures 149 that define outlets for reduced material. Material that gets past anvil 136 will be further reduced by contact with the tools on drum rotor 114 and breaker bar assembly 138. Material that gets past the breaker bar assembly may be further reduced by contact with the tools on the drum rotor in the space between the tools mounted on the drum rotor and screen sections 144, 146 and 148. Reduced material (such as material 12b shown in FIGS. 1-4) may then pass through apertures 149 in one or another of the screen sections and onto output conveyor 150 for removal from the machine. Material that does not pass through the apertures in any of the screen sections on a first pass may be carried around by the tools mounted on the drum rotor one or more additional times for further contact with anvil 136, breaker bar assembly 138 and screen sections 144, 146 and 148, until it passes through the apertures in one or another of the screen sections and is carried out of the machine.

When an object that cannot be reduced (such as object 12c shown in FIGS. 1-3) encounters the anvil, the force of the impact of the object on the anvil, either alone or in combination with the added impact forces imparted to the object by the tools of rotating drum rotor 114, will apply an opening force to the anvil, and thereby to bypass arm 190, which is sufficient to overcome the predetermined forces imposed by spring 196 and allow bypass arm 190 to pivot with respect to pivot shaft 128. When this occurs, the bypass arm will move from the closed position (similar to that of bypass arm 90 shown in FIG. 2) to the open position (similar to that of bypass arm 90 shown in FIG. 3) and compression will be applied to spring 196. Then, when an object such as object 12c has cleared anvil 136 and breaker bar assembly 138, the opening force is removed from anvil 136, and spring 196 may apply a biasing force to move bypass arm 190 to the closed position.

A second embodiment of the invention is illustrated in FIG. 7. As shown therein, material reducing machine 210 includes frame 212 and input conveyor 113. Conveyor 113 is adapted to move material to be reduced (such as material 12a shown in FIGS. 1-4) toward drum rotor 114, which has a generally cylindrical peripheral wall 115. Drum rotor 114 is adapted to rotate in a clockwise direction, as shown in FIG. 7, about axis of rotation 116. Mounted on peripheral wall 115 of drum rotor 114 are a plurality of tools comprising tool holders 117 with cutting bits 118 mounted thereon. These tools are spaced around the peripheral wall of the drum rotor so that as the drum rotor is rotated, the tools carry material from conveyor 113 upwardly and into engagement with breaker bar assembly 138 that is mounted on bypass arm 290. The leading edges of the cutting bits of the tools mounted on drum rotor 114 define an arc that is spaced outwardly from peripheral wall 115 and is parallel thereto. A portion 139 of this arc is shown in FIG. 7.

Compression roller 220 includes ribs 222 and is mounted on pivot arm 224. Pivot arm 224 is mounted for rotation on pivot shaft 228. Bypass arm 290 is also mounted for rotation on pivot shaft 228 (in front of pivot arm 224, as shown in FIG. 7), so that the bypass arm may pivot on pivot shaft 228 independently of pivot arm 224. Collar 229 is provided on pivot shaft 228 so that a first resistance and biasing mechanism, such as spring 256, may be mounted between frame 212 of machine 210 and collar 229 to provide for limited upward elastic movement of the pivot shaft to minimize the risk of damage or breakage of pivot shaft 228 caused by forces generated during operation of the reducing machine. The weight and placement of pivot arm 224 and compression roller 220 cause the compression roller to urge material on conveyor 113 downwardly and towards drum rotor 114.

As shown in FIG. 7, breaker bar assembly 138 is mounted on bypass arm 290; however, back plate 140 of breaker bar assembly 138 is oriented so that it is not parallel to the arc that is described by the leading edges of cutting bits 118 as drum rotor rotates about axis 116, a portion of which is shown as arc 139 in FIG. 7. Consequently, the placement of breaker bar assembly 138 in this embodiment of the invention provides a larger gap between the arc described by the leading edges of the cutting bits 118 and the breaker bar assembly at the top of the breaker bar assembly, and this gap narrows towards the bottom of the breaker bar assembly. Although breaker bar assembly 138 is curved as shown in FIG. 7, other embodiments of the invention may employ a breaker bar assembly having a back plate that is straight (not shown), or angled or curved differently from that of breaker bar assembly 138.

A second resistance and biasing mechanism, such as spring 296, is mounted between the frame of the machine and rear end 295 of bypass arm 290 and adapted to urge the breaker bar assembly towards drum rotor 114. Material that is too large to pass between the tools on drum rotor 114 and the upper end of breaker bar assembly 138 may be broken into smaller pieces upon impacting the breaker bar assembly. In this embodiment of the invention, there are no screen sections (such as screen sections 144, 146 and 148 of the embodiment shown in FIG. 6), so that the outlet for reduced material is defined by the openings downstream of breaker bar assembly 138 (that are occupied by screen sections 144, 146 and 148 in the embodiment of FIG. 6). Of course, the orientation of breaker bar assembly 138 shown in FIG. 7 could be used with an embodiment of the invention that included screen sections such as screen sections 144, 146 and 148 of FIG. 6. Similarly, the orientation of breaker bar assembly shown in FIG. 6 could be used with an embodiment of the invention that includes no screen sections.

In the embodiment of the invention illustrated in FIG. 7, material that gets past the upper portion of breaker bar assembly will be further reduced by contact with the tools on the drum rotor and the curved breaker bar assembly 138. Material that gets past the breaker bar assembly may then fall onto conveyor 150 for removal from the machine. When an object that cannot be reduced (such as object 12c shown in FIGS. 1-3) encounters the breaker bar assembly, the force of the impact of the object on the breaker bar assembly, either alone or in combination with the added impact forces imparted to the object by the tools on rotating drum rotor 114, will cause bypass arm 290 to pivot on pivot shaft 228 from the closed position (similar to that of bypass arm 90 shown in FIG. 2 and that of bypass arm 190 shown in FIG. 6) to the open position (similar to that of bypass arm 90 shown in FIG. 3). Then, when an object such as object 12c has cleared breaker bar assembly 138, the opening force is removed, and spring 296 may apply a biasing force to move bypass arm 290 to the closed position.

Although this description contains many specifics, these should not be construed as limiting the scope of the invention but as merely providing illustrations of the presently preferred embodiments thereof, as well as the best mode contemplated by the inventor of carrying out the invention. The invention, as described herein, is susceptible to various modifications and adaptations, as would be understood by those having ordinary skill in the art to which the invention relates.

What is claimed is:

1. A material reducing machine comprising:
(a) a frame;
(b) a drum rotor which is mounted for rotation with respect to the frame, said drum rotor comprising a generally cylindrical peripheral wall;
(c) a tool mounted on the peripheral wall of the drum rotor, said tool having a leading edge that defines an arc as the drum rotor is rotated, which arc is spaced outwardly from the peripheral wall and is parallel thereto;
(d) means for rotating the drum rotor with respect to the frame;
(e) a material input device for conveying material to be reduced towards the drum rotor;
(f) an outlet for reduced material;
(g) a breaker bar assembly that is located adjacent to the drum rotor, said breaker bar assembly:
(i) including a back plate with a plurality of breaker bars mounted thereon;
(ii) being located so that material which is carried by the tool of the drum rotor is directed against the breaker bar assembly.

2. The material reducing machine of claim 1, wherein the outlet for reduced material is defined by at least one screen section that is located downstream of the breaker bar assembly.

3. The material reducing machine of claim 1, wherein the back plate of the breaker bar assembly includes apertures through which material may pass, which apertures comprise a part of the outlet for reduced material.

4. The material reducing machine of claim 1, wherein the breaker bars are spaced equally across the back plate, and the width of each breaker bar is within the range of 25-50% of the width of the spacing between adjacent breaker bars in the breaker bar assembly.

5. The material reducing machine of claim 1, wherein the breaker bars are spaced equally across the back plate, and the width of each breaker bar is about ⅜ the width of the spacing between adjacent breaker bars in the breaker bar assembly.

6. The material reducing machine of claim 1, wherein the back plate is oriented so that a larger gap is provided between the leading edge of the tool and the breaker bar assembly at the top of the breaker bar assembly than between the leading edge of the tool and the breaker bar assembly at the bottom of the breaker bar assembly.

7. The material reducing machine of claim 1, wherein the back plate of the breaker bar assembly is curved.

8. The material reducing machine of claim 7, wherein the back plate is placed so as to describe an arc that is parallel to and of a larger diameter than the arc that is described by the leading edge of the tool.

9. The material reducing machine of claim 7, wherein the back plate is oriented so that it is not parallel to the arc that is described by the leading edge of the tool, so that a larger gap is provided between the leading edge of the tool and the breaker bar assembly at the top of the breaker bar assembly than between the leading edge of the tool and the breaker bar assembly at the bottom of the breaker bar assembly.

10. The material reducing machine of claim 7, wherein the outlet for reduced material is defined by a screen section that:
(i) is curved at the same diameter as the back plate of the breaker bar assembly; and
(ii) is mounted downstream of the breaker bar assembly.

11. The material reducing machine of claim 1 which includes:
(a) a pivot shaft;
(b) a pivot arm that is mounted for rotation on the pivot shaft, said pivot arm having a compression roller at its forward end;
(c) a first resistance and biasing mechanism that is mounted between the frame and the pivot shaft;
(d) a bypass arm that is mounted for rotation on the pivot shaft, said bypass arm:
(i) being adapted to pivot on the pivot shaft independently of the pivot arm;
(ii) having the breaker bar assembly attached thereto;
(e) a second resistance and biasing mechanism that is mounted between the frame and the bypass arm behind the breaker bar assembly.

12. The material reducing machine of claim 11 which includes an anvil that is mounted on the bypass arm upstream of the breaker bar assembly.

13. A material reducing machine comprising:
(a) a frame;
(b) a drum rotor which is mounted for rotation with respect to the frame, said drum rotor comprising a generally cylindrical peripheral wall;
(c) a plurality of tools mounted on the peripheral wall, at least one of which tools has a leading edge that defines an arc when the drum rotor is rotated, which arc is spaced outwardly from the peripheral wall and is parallel thereto;
(d) means for rotating the drum rotor with respect to the frame;
(e) an input conveyor for conveying material to be reduced towards the drum rotor;
(f) a pivot shaft;
(g) a pivot arm that is mounted for rotation on the pivot shaft, said pivot arm having a compression roller at its forward end;
(h) a first resistance and biasing mechanism that is mounted between the frame and the pivot shaft and adapted to allow limited upward elastic movement of the pivot shaft;
(i) a bypass arm having a rear end that is mounted for rotation on the pivot shaft, said bypass arm being adapted to pivot on the pivot shaft independently of the pivot arm;
(j) a breaker bar assembly that is mounted to the bypass arm, said breaker bar assembly:
(i) including a back plate with a plurality of breaker bars mounted thereon;
(ii) being located so that material which is carried by the tool of the drum rotor is directed against the breaker bar assembly;
(k) a second resistance and biasing mechanism that is mounted between the frame and the rear end of the bypass arm and adapted to urge the breaker bar assembly towards the drum rotor;
(l) an outlet for reduced material comprising a screen section that is located downstream of the breaker bar assembly.

14. The material reducing machine of claim 13 which includes an anvil that is mounted on the bypass arm upstream of the breaker bar assembly.

15. The material reducing machine of claim 13, wherein the breaker bars are spaced equally across the back plate, and the width of each breaker bar is within the range of 25-50% of the width of the spacing between adjacent breaker bars in the breaker bar assembly.

16. The material reducing machine of claim 13, wherein the breaker bars are spaced equally across the back plate, and the width of each breaker bar is about ⅜ the width of the spacing between adjacent breaker bars in the breaker bar assembly.

17. The material reducing machine of claim 13, wherein the back plate of the breaker bar assembly is curved.

18. The material reducing machine of claim 17, wherein the back plate is placed so as to describe an arc that is parallel to and of a larger diameter than the arc that is described by the leading edge of the tool.

19. The material reducing machine of claim 17, wherein the back plate is oriented so that it is not parallel to the arc that is described by the leading edge of the tool, so that a larger gap is provided between the leading edge of the tool and the breaker bar assembly at the top of the breaker bar assembly than between the leading edge of the tool and the breaker bar assembly at the bottom of the breaker bar assembly.

20. The material reducing machine of claim 17, wherein the outlet for reduced material is defined by a screen section that is curved at the same diameter as the back plate of the breaker bar assembly.
